(19) United States
(12) Patent Application Publication
(10) Pub. No.: US 2009/0168400 A1
(43) Pub. Date: Jul. 2, 2009

(54) LIGHT EMITTING FRAME AND HEATING DISSIPATING FAN USING THE SAME

(76) Inventor: Wen-Chi LIU, Taoyuan Hsien (TW)

Correspondence Address: Joe McKinney Muncy, PO Box 1364, Fairfax, VA, 22038-1364, US

(21) Appl. No.: 11/965,597

(22) Filed: Dec. 27, 2007

(51) Int. Cl. F21V 33/00

(52) U.S. Cl. 362/96

(57) ABSTRACT

In a light emitting frame and a heat dissipating fan using the light emitting frame, a light emitting element can be installed freely on the heat dissipating fan by a detachable light emitting frame composed of a separate main frame body, and the main frame body has a limit position portion passed through by a same fixing element, such that when the heat dissipating fan is installed to an electronic device, the light emitting frame is fixed. The invention overcomes the shortcomings of a prior art design of integrating the light emitting element with the heat dissipating element. In addition to lowering the manufacturing cost, the invention provides a number of selections for the material of the light emitting element and the light projecting angle.

### FIELD OF THE INVENTION

The present invention relates to a light emitting frame and a heat dissipating fan using the light emitting frame, and more particularly to a fan that provides a heat dissipating effect by guiding an airflow and a light emitting frame that provides a fabulous color effect during the operation of the heat dissipating fan to improve the aesthetic look of the fan.

### BACKGROUND OF THE INVENTION

To maintain a stable operation of an electronic device and prevent damages caused by accumulated heat, a heat dissipating fan is generally installed to the electronic device for guiding airflows to achieve a heat dissipating effect. Obviously, the aforementioned beat dissipating fan is one of the indispensable components. Besides the research and development of the existing heat dissipating effect, the rotation of vanes can also give a fabulous and colorful visual effect during the operation of the heat dissipating fan, and thus the aforementioned heat dissipating fan has become a trend of the new-generation mainstream fans. Related technologies are disclosed in R.O.C. Patent Publication Nos. M241715, M255640, MB260084, M268644, M279744 and M290267.

Regardless of using a light bulb or a light emitting diode as a light emitting element, the technical characteristics of the aforementioned patents reside on that a containing hole of the light emitting element is designed and formed integrally with vanes or a frame of a heat dissipating fan, and a plurality of power cables are divided from a circuit board disposed at a central stator structure of the heat dissipating fan for supplying electric power to the light emitting element installed in the containing hole. In such design and technology, the light emitting element and the heat dissipating fan are integrally formed with each other, and the power source of the light emitting element can be supplied by connecting a power supply of the heat dissipating fan, and thus the operation is still considered to be convenient, but the integral design has a drawback on the control of a defective rate. If the heat dissipating fan or any one of the light emitting elements is damaged or defective (such as an uneven brightness of the light emitting elements), then the whole set of the installed heat dissipating fan becomes a defective item which cannot be recycled or reworked separately. A higher manufacturing cost will be incurred for the control of the defective rate. Furthermore, the design of the integral injection of the containing hole is lack of flexibility for changes. If it is necessary to change a projecting angle, a specification or a dimension of a light emitting element, the whole heat dissipating fan requires a redesign, which is definitely not cost-effective. In addition, a user's requirement for a visual change cannot be satisfied if a user wants to change a light emitting element to a different combination of colors, since the present invention only provides a heat dissipating fan with a single-color light emitting system, and this limited specification no longer can meet a user's requirement for their expected fabulous colorful effects of a light emitting element, and the prior art is simply considered as a heat dissipating fan that can emit light only.

### SUMMARY OF THE INVENTION

In view of the foregoing shortcoming of the prior art, the present invention has a primary objective of overcoming the foregoing shortcomings and avoiding the deficiency by designing a light emitting frame in the form of a separate sheathing component, so that users can freely combine the light emitting frames of various different specifications to produce fabulous colors on the heat dissipating fan according to the dimensions, colors and light projecting angles.

To achieve the foregoing objectives, the present invention provides a light emitting frame composed of at least one light emitting element installed at a main frame body, and the light emitting frame is a separate component freely and selectively installed onto a heat dissipating fan, and the main frame body further comprises a limit position portion passed by a same fixing element, so that the heat dissipating fan can be installed to an electronic device, while fixing the light emitting frame to overcome the shortcomings of the traditional light emitting elements having a design of being integrated with the heat dissipating element. In addition to lowering the manufacturing cost, the invention provides a number of selections for the material of the light emitting element and the light projecting angle.

### BRIEF DESCRIPTION OF THE DRAWINGS

FIG. 1 is a perspective view of a heat dissipating fan mounted onto a light emitting frame in accordance with the present invention;

FIGS. 2A and 2B are exploded views of the structure of a heat dissipating fan and a light emitting frame in accordance with the present invention;

FIGS. 3A and 3B are schematic views of each viewing angle of a main frame body in accordance with the present invention;

FIGS. 4 and 5 are cross-sectional views of an assembly in accordance with the present invention; and

FIG. 6 is a schematic view of a heat dissipating fan installed to an electronic device in accordance with a preferred embodiment of the present invention.

### DETAILED DESCRIPTION OF THE PREFERRED EMBODIMENTS

The technical contents of the invention will now be described in more detail hereinafter with reference to the accompanying drawings that show various embodiments of the invention.

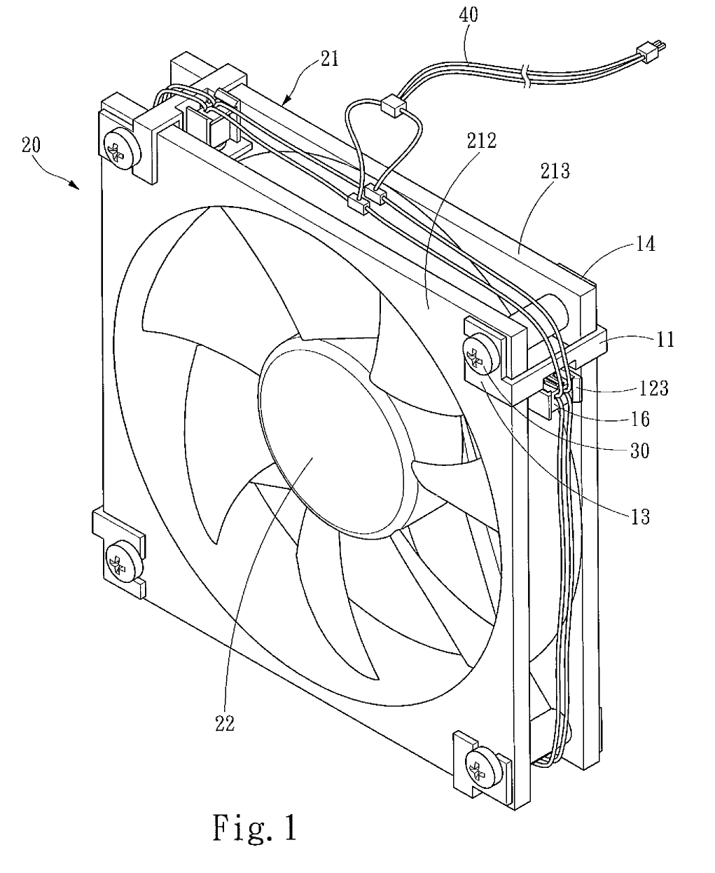

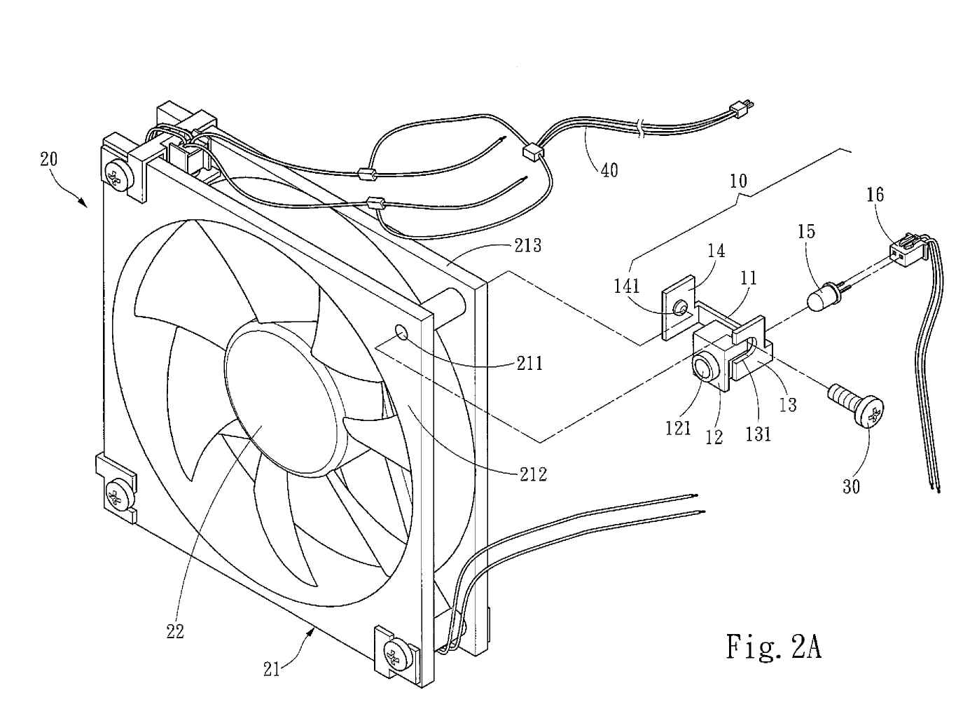

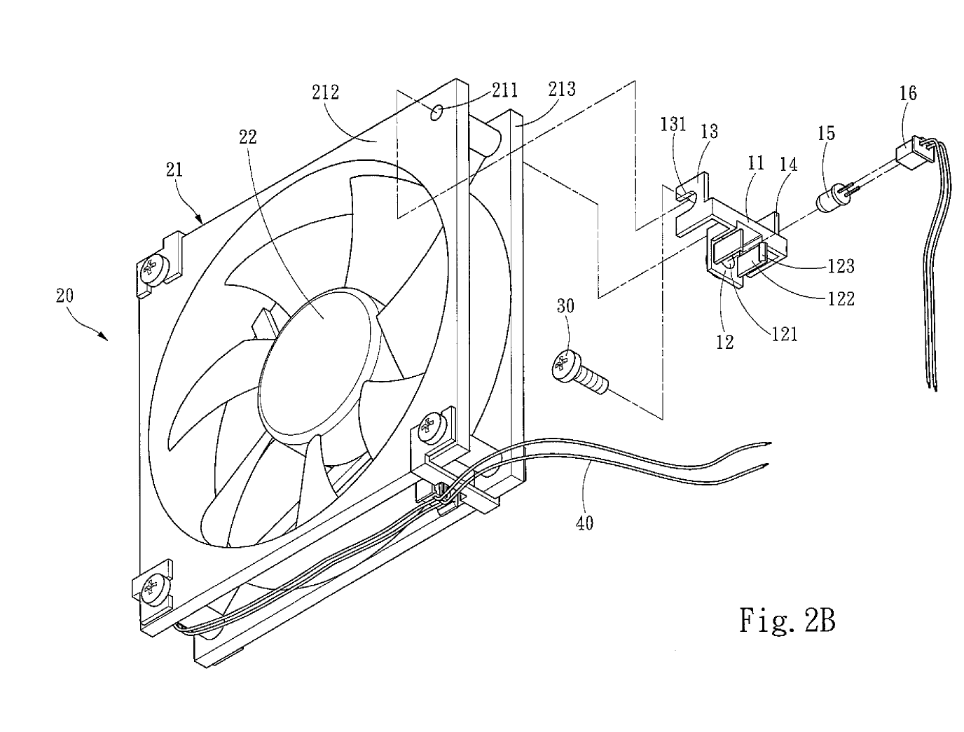

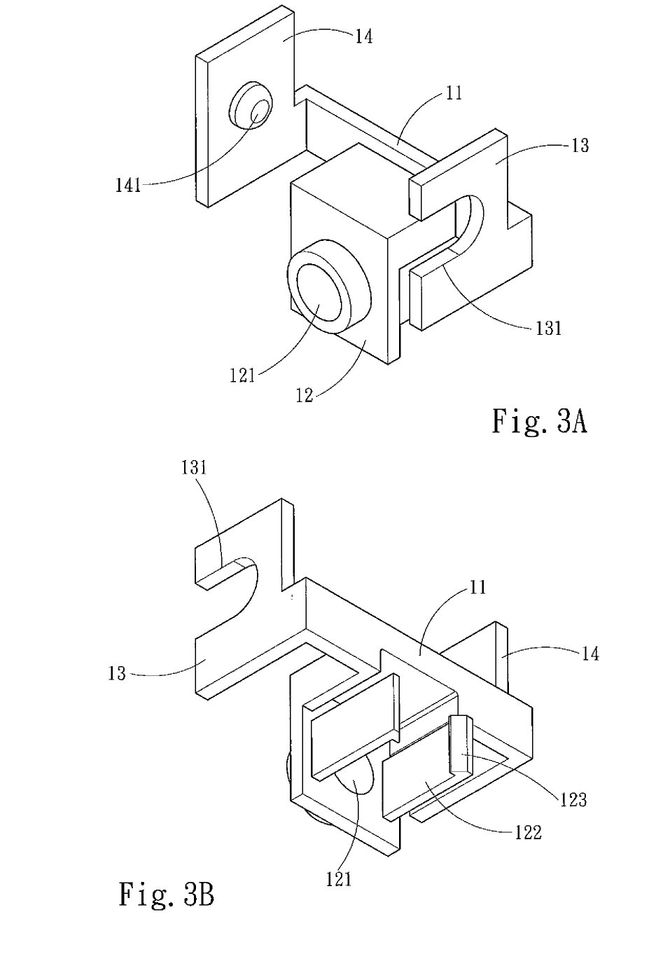

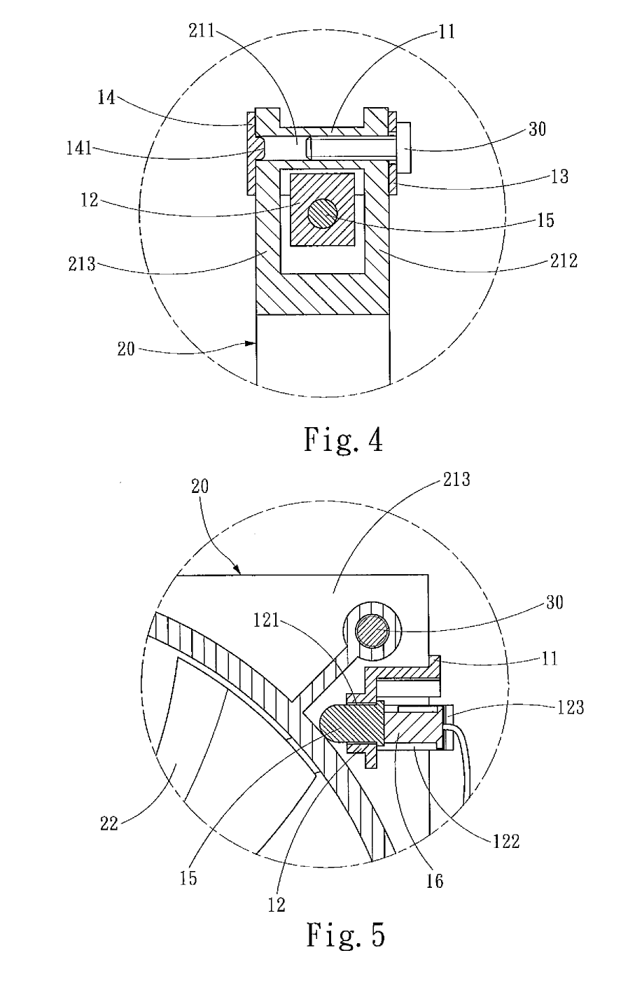

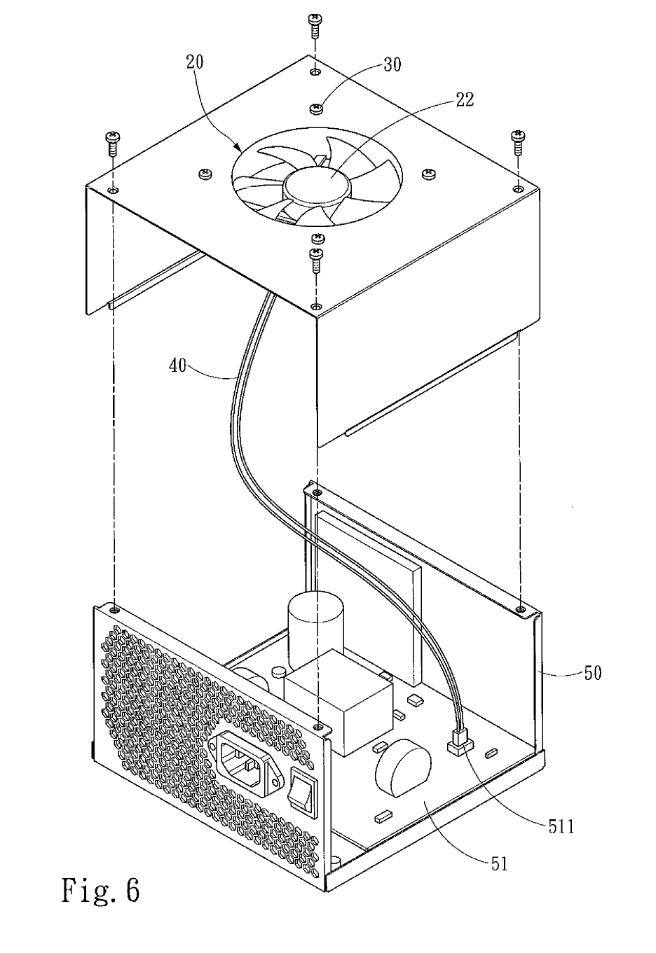

Referring to FIGS. 1, 2A, 2B, 3A and 3B for a perspective view and exploded views of the present invention respectively, the invention relates to a light emitting frame 10 and a heat dissipating fan 20 using the light emitting frame 10. The light emitting frame 10 comprises at least one light emitting element 15 installed on a main frame body 11, and the main frame body 11 having a containing portion 12 disposed on the light emitting element 15, and a limit position portion 13 extended and formed on at least one lateral side of the containing portion 12, and the limit position portion 13 has a limit position hole 131 for passing a fixing element 30 to fix the main frame body 11 onto a heat dissipating fan 20. The heat dissipating fan 20 of the embodiment comprises a frame 21 and vanes 22 installed in the frame 21. In the embodiment, the light emitting frame 10 is fixed onto the frame 21 in the preferred embodiment, wherein the frame 21 has a distal portion 211 at the electronic device 50, and the distal portion 211 has a positioning hole for installing the fixing element 30 and passing and fixing the light emitting frame 10 to the electronic device 50. The frame 21 of the heat dissipating fan 20 is comprised of a front plate 212 and a rear plate 213, and the limit position portion 13 is extended from the containing portion 12 towards the front plate 212, and another limit position portion 14 is extended towards the rear plate 213, such that the containing portion 12 is limited between the front plate 212 and the rear plate 213. The containing portion 12 includes a lamp hole 121 for passing a light emitting element 15, and the lamp hole 121 is opened in a direction based on the light projecting angle and being a vertical angle or a slant guide angle with respect to the vanes 22 to ensure that the light emitting element 15 in the lamp hole 121 is maintained at a desired light projecting angle without producing a deviation to the centrifugal force produced by the operation of the heat dissipating fan 20, and a latch portion 122 is extended from the periphery of the lamp hole 121 and has an inverted hook 123 disposed separately on both ends, and a power socket 16 is disposed between the latch portions 122 and electrically connected to the light emitting element 15. The latch portion 122 is provided for embedding and restricting the power socket 16 and the light emitting element 15, so that the light emitting element 15 is secured and limited in the containing portion 12. In FIGS. 4 and 5, a positioning protrusion 141 is disposed on the limit position portion 14 to facilitate the installation of the light emitting frame 10 to the heat dissipating fan 20, and the flexibility of the material of the light emitting frame 10 is used for the plastic injection process. The positioning protrusion 141 is installed precisely to a distal portion 211 of the rear plate 213 of the frame 21, and a small force is applied to another limit position portion 13 to slightly deform the light emitting frame 10 and allow another limit position portion 13 to fall into the distal portion 211 of the front plate 212. Before the light emitting frame 10 is passed and fixed to the heat dissipating fan 20 by the fixing element 30, the two limit position portions 13, 14 clamp the frame 21 by a flexible pressing force to a predetermined fixing state, and the light emitting frame 10 is installed at a plurality of distal portions 211 of the frame 21 and electrically connected in series to a power cable 40, such that a user can pass the heat dissipating fan 20 into the distal portion 211 by the fixing element 30 and fix the heat dissipating fan 20 to the electronic device 50 (as shown in FIG. 6), and fix the light emitting frame 10 by passing the fixing element 30, so as to complete the positioning and installation

Referring to FIG. 6, the light emitting frame is installed to the electronic device 50 in accordance with a preferred embodiment of the present invention, the light emitting element 15 can be a light emitting diode or a light bulb. The light emitting frame 10 of the invention is installed between the front plate 212 and the rear plate 213 of the frame 21, and thus the light emitting element 15 can have a specification with larger dimensions. In addition, the heat dissipating fan 20 as shown in FIG. 6 is installed to the electronic device 50 which is a power supply device for supplying electric power to the light emitting element 15, and a power cable 40 for driving electric power can be connected directly to a terminal socket 511 on a circuit board 51 in the electronic device 50, or a conducting wire groove (not shown in the figure) is created on a traditional frame 21 for connecting electric power. It is noteworthy to point out that the present invention is not limited to such arrangement only, but various different types of electric connection technologies can be adopted for the invention.

While the invention has been described by means of specific embodiments, numerous modifications and variations could be made thereto by those skilled in the art without departing from the scope and spirit of the invention set forth in the claims.

What is claimed is:

1. A light emitting frame and a heat dissipating fan using the light emitting frame, comprising:
at least one light emitting element; and
a main frame body, having a containing portion disposed thereon for installing the light emitting element, and a limit position portion extended from at least one lateral side of the containing portion, and the limit position portion having a limit position hole for passing through a fixing element to fix the main frame body onto a heat dissipating fan.

2. The light emitting frame and the heat dissipating fan using the light emitting frame of claim 1, wherein the light emitting element is a light emitting diode.

3. The light emitting frame and the heat dissipating fan using the light emitting frame of claim 1, wherein the light emitting element is a light bulb.

4. The light emitting frame and the heat dissipating fan using the light emitting frame of claim 1, wherein the containing portion comprises a lamp hole for passing and installing the light emitting element.

5. The light emitting frame and the heat dissipating fan using the light emitting frame of claim 4, further comprising a latch portion disposed separately on both ends of the periphery of the lamp hole and having an inverted hook, and between the latch portions and a power socket electrically connected to the light emitting element.

6. The light emitting frame and the heat dissipating fan using the light emitting frame of claim 1, wherein the heat dissipating fan comprises a frame and a plurality of vanes installed in the frame, and the light emitting frame is fixed onto the frame.

7. The light emitting frame and the heat dissipating fan using the light emitting frame of claim 6, wherein the frame includes a distal portion installed to an electronic device, and a positioning hole disposed on the distal portion for installing the fixing element, while passing and fixing the light emitting frame onto the electronic device.

8. The light emitting frame and the heat dissipating fan using the light emitting frame of claim 6, wherein the frame comprises a front plate and a rear plate, and the limit position portion is extended from the containing portion towards the front plate and another limit position portion is extended towards the rear plate, so that the containing portion is limited between the front plate and the rear plate.

9. The light emitting frame and the heat dissipating fan using the light emitting frame of claim 8, wherein the limit position portion includes a positioning protrusion disposed thereon.

10. The light emitting frame and the heat dissipating fan using the light emitting frame of claim 7, wherein the light emitting frame is installed to a plurality of distal portions of the frame and electrically connected in series with a power cable.
